(19) United States
(12) Patent Application Publication
(10) Pub. No.: US 2026/0145582 A1
(43) Pub. Date: May 28, 2026

(54) TRACKED VEHICLE, A TRACKED VEHICLE CONTROL METHOD AND A CHARGING SYSTEM OF THE TRACKED VEHICLE

(71) Applicant: PRINOTH S.P.A., Vipiteno (IT)

(72) Inventors: Francesco Salis, Vipiteno (IT); Georg Rautscher, Vipiteno (IT); Roberto Pegoraro, Vipiteno (IT); Alberto Paoletti, Vipiteno (IT)

(21) Appl. No.: 19/178,462

(22) Filed: Apr. 14, 2025

(30) Foreign Application Priority Data
Apr. 16, 2024 (IT) 102024000008644

(51) Int. Cl. B60L 58/25; B60L 53/62; B60L 58/12; B60L 58/26; B60L 58/27; H01M 10/613; H01M 10/615; H01M 10/625; H01M 10/633

(52) U.S. Cl. CPC B60L 58/25; B60L 53/62; B60L 58/12; B60L 58/26; B60L 58/27; H01M 10/613; H01M 10/615; H01M 10/625; H01M 10/633; B60L 2260/22

(57) ABSTRACT

A method for controlling electric or hybrid plug-in electric tracked vehicle, such as a snow groomer. The method includes operating in a first operating mode when the rechargeable battery assembly is not fully charged and, in the first operating mode, the tracked vehicle requests and receives current and supplies the current to the rechargeable battery assembly. The method also includes operating in a second operating mode when the rechargeable battery assembly is fully charged and, in the second operating mode, the tracked vehicle requests and receives current and is controlled so as to consume at least a minimum current value greater than a given current threshold continuously and without interruptions, supplying the current to the heater assembly so that it consumes the minimum current value.

### PRIORITY CLAIM

This application claims the benefit of and priority to Italian Patent Application No. 102024000008644 filed on Apr. 16, 2024, the entire contents of which is incorporated by reference herein.

### TECHNICAL FIELD

The present disclosure relates to each of a tracked vehicle, such as a snow groomer, a method for the control of the tracked vehicle and a charging system comprising the tracked vehicle. In particular, the disclosure relates to electric or plug-in hybrid electric tracked vehicles, in particular snow groomers.

### BACKGROUND

Certain known plug-in hybrid electric or electric tracked vehicles comprise a rechargeable battery assembly, such as a traction battery assembly, which supplies energy to an electric motor assembly, comprising one or more electric motors. The electric motor assembly in turn supplies kinetic energy to one or more of operating devices, in particular tracks and/or one or more accessories, such as a tiller, a blade and/or a winch. As a consequence, the rechargeable battery assembly needs to be charged at the end of the work cycle, such as during a stop. The rechargeable battery assembly is usually charged by a charging station, in which there is an electrical connector (with or without a built-in charging cable) and an electronic control unit. The electronic control unit controls the current and/or the voltage supplied while charging (in certain instances in communication with an electronic control unit of the vehicle which manages the input current). The battery assembly has a first allowed operating temperature range and a second optimal operating temperature range, which is comprised within the first temperature range. In other words, the second temperature range is a sub-set of the first temperature range. For instance, below a given temperature (for example −10° C., but depending on the type of battery), the rechargeable battery assembly does not supply current. Consequently, in these instances, certain problems arise when the tracked vehicle is used in environments with a harsh climate.

Another drawback of certain known plug-in hybrid electric or electric tracked vehicles is that there are different types of charging stations, in which each control unit of the charging station acts differently and unevenly with respect to the others, especially in terms of deactivation of the charge. In particular, once the current supplied by the charging station drops to zero (for example when the rechargeable battery assembly has reached a 100% charge), the electronic control unit of the charging station ends the supply of current. In these instances, it will no longer be possible to reactivate the supply of current except with a manual procedure and/or with the intervention of an operator. Such a configuration entails, as a drawback, that any utilities of the electric tracked vehicles or plug-in hybrid electric tracked vehicle (other than the charging of the battery assembly), which require current (such as according to a cyclic activation and deactivation interval (for example, with a cyclic duty-cycle ON-OFF), are definitively prevented from being powered or alternatively must obtain energy from the rechargeable battery assembly (thus at least partially discharging the rechargeable battery assembly).

### SUMMARY

An object of the present disclosure is to provide a method for controlling an electric or plug-in hybrid electric tracked vehicle, which reduces or overcomes at least certain of the above-described drawbacks.

According to the disclosure, there is provided a method for controlling a tracked vehicle including a rechargeable battery assembly, a heater assembly, a cooler assembly, and an electrical connector configured to receive input current. In these embodiments, the method includes operating in a first operating mode when the rechargeable battery assembly is at least one of not fully charged and charged to less than a threshold percentage of charge, wherein in the first operating mode, the tracked vehicle requests and receives current and supplies the current to the rechargeable battery assembly and at least one of the heater assembly and the cooler assembly. In these embodiments, the method also includes operating in a second operating mode when the rechargeable battery assembly is at least one of fully charged and charged to at least the threshold percentage of charge, wherein in the second operating mode, the tracked vehicle requests and receives current and is controlled to consume at least a minimum value of current greater than a determined current threshold continuously and, without interruption, supplying the current to at least one of the heater assembly and the cooler assembly controlled to collectively consume at least the minimum value of current.

In accordance with certain embodiments of the present disclosure, the electric or plug-in hybrid electric tracked vehicle remains electrically connected for the entire stop at the charging station regardless of the type of charging station, regardless of the charging standard and regardless of the type of charging (direct current or alternating current) and further regardless of the charging station operating as a master and the vehicle operates as a slave (or vice versa). Such a configuration makes it possible to power the utilities, such as to heat or cool one or more of the battery, the cabin, oil of at least one hydraulic circuit, and/or a portion of the tracked vehicle, for the entire duration of the stop. As a consequence, the tracked vehicle, such as a snow groomer, will always be ready to start again after the stop, even if the latter was prolonged and/or at relatively very low temperatures (e.g., below zero degrees Celsius). In particular, the battery, the cabin and/or the oil will always be in the optimal condition of use and ready to start.

In particular, in accordance with the present disclosure, the rechargeable battery assembly can constantly be heated (and, if necessary, cooled) so as to maintain it in the second optimal operating temperature range or at least in the first allowed operating temperature range. In this way, the vehicle can also be parked outside and/or at a temperature well below zero, while ensuring its relative availability and readiness for use.

A further object of the disclosure is to provide an electric or plug-in hybrid electric tracked vehicle, such as a snow groomer, which reduces or overcomes certain of the drawbacks discussed above. In certain such embodiments, there is provided an electric or plug-in hybrid electric tracked vehicle, such as a snow groomer, including a rechargeable battery assembly, a heater assembly, a cooler assembly, an electrical connector configured to receive an input current, and an electronic control unit. The electronic control unit is configured to manage the received input current, operate in a first operating mode when the rechargeable battery assembly is at least one of not fully charged and charged to less than a threshold percentage of charge and operate in a second operating mode when the rechargeable battery assembly at least one of fully charged and charged to at least the threshold percentage of charge. In these embodiments, in the first operating mode, the electronic control unit is configured to request and receive current from the electrical connector and supply current to the rechargeable battery assembly and at least one of the heater assembly and the cooler assembly and in the second operating mode, the electronic control unit is configured to request and receive current and control at least one of the heater assembly and the cooler assembly so that they always consume at least a minimum value of current greater than a determined current threshold.

A further object of the disclosure is to provide a charging system, which mitigates at least certain of the drawbacks of certain of the prior art. According to certain embodiments of disclosure, there is provided a charging station configured to deliver at least one of alternating current and direct current. The charging station includes an electronic control unit configured to operate as one of a master and a slave with respect to a electronic control unit of such a tracked vehicle.

### BRIEF DESCRIPTION OF THE DRAWINGS

Further features and advantages of the present disclosure are defined in the appended dependent claims and will be best understood upon perusal of the following description of a non-limiting embodiment, with reference to the accompanying figures, wherein:

FIG. 1 is a schematic side view, with parts removed for greater clarity, of a tracked vehicle, in particular a snow groomer, according to the disclosure; and

FIG. 2 is a top view, with parts removed for greater clarity and parts shown in a block diagram, of a charging system comprising the tracked vehicle of FIG. 1 and a charging station.

### DETAILED DESCRIPTION

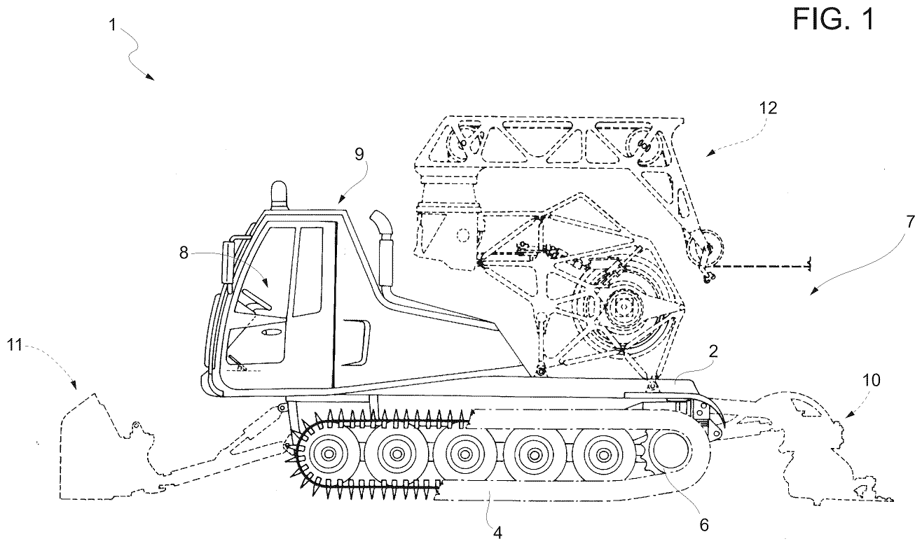

With reference to FIG. 1, reference number 1 shows a tracked vehicle, in particular, a snow groomer.

In particular, the disclosure relates to an electric tracked vehicle (also called BEV) or a plug-in hybrid electric tracked vehicle (also called PHEV), which, in certain instances, comprises a rechargeable traction battery assembly.

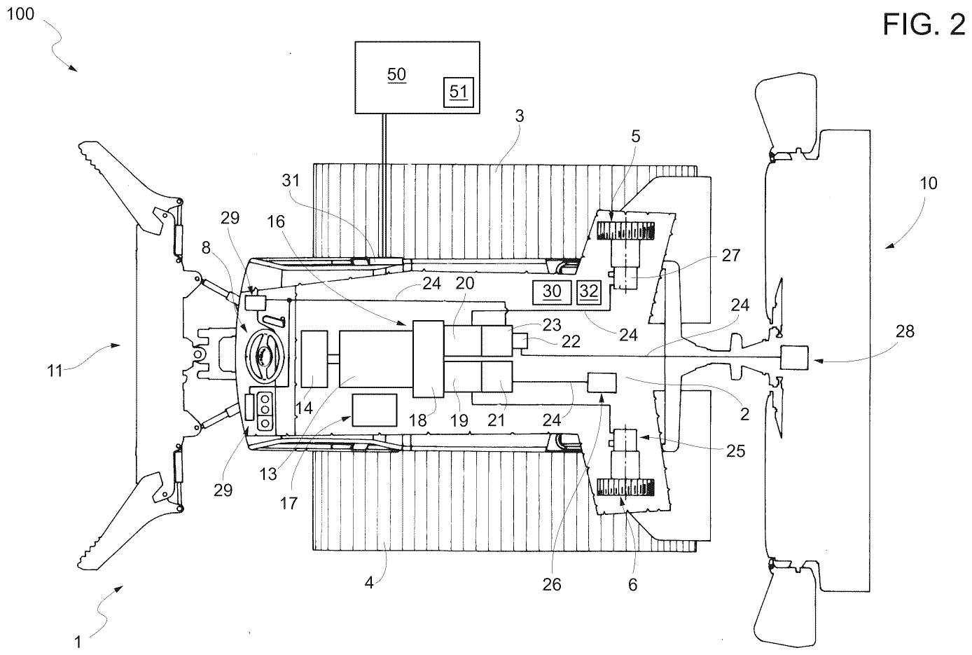

The snow groomer vehicle 1 comprises a frame 2; a first track 3 (FIG. 2); a second track 4; a first drive wheel 5 (FIG. 2) and a second drive wheel 6, which are independent of one another and are coupled to the first track 3 (FIG. 2) and to the second track 4, respectively; a group of operating devices 7; a user interface 8; and a cabin 9. In this specific case and with reference to FIG. 2, the group of operating devices 7 (FIG. 1) comprises the first drive wheel 5; the second drive wheel 6; and, in certain embodiments, one or more of the following accessories: a tiller 10; a blade 11; and a winch 12 (FIG. 1). In certain embodiments, one or more or all of the accessories, namely the tiller 10, the blade 11, and the winch 12, is/are omitted.

With reference to FIG. 2, the tracked vehicle 1 comprises a rechargeable battery assembly 14; an electric motor assembly 13 electrically powered by the rechargeable battery assembly 14; in certain instances, a power transmission 16 operatively designed to connect the electric motor assembly 13 to the group of operating devices 7 (FIG. 1); a heater assembly 30; an electrical connector 31 configured to receive input power; an electric control unit 17 configured to manage the received input power and, in certain embodiments, the heater assembly 30.

The electric motor assembly 13 comprises one or more electric motors. In particular, the electric motor assembly 13 is connected to the rechargeable battery assembly 14 through an inverter or without the use thereof. In certain non-limiting embodiments of the present disclosure, the electric motor assembly 13 comprises one or more inverters. By way of non-limiting examples, the rechargeable battery assembly 14 comprises lithium or lithium ions.

In certain non-limiting embodiments of the present disclosure, the electric motor assembly 13 is operatively connected to the group of operating devices 7 in a direct manner and/or through one or more transmission shafts of the electric motor assembly 13. Consequently, the power transmission 16 can, in certain instances, be omitted at least in part or entirely. In these embodiments, the electric motor assembly 13 can comprise one single electric motor or several electric motors, which power more than one working device 7, or one electric motor for each respective operating device 7.

In certain non-limiting embodiments, the rechargeable battery assembly 14 can comprise one or more rechargeable batteries, each comprising a number of cells in series and/or in parallel.

In certain non-limiting embodiments, the heater assembly 30 can comprise one single heater with one or more heating circuits; or several heaters, which are independent of one another, such as each with its own heating circuit; or one or more heaters, wherein one or more or all work together in one or more groups of heaters and wherein the heaters of a same group of heaters share a same heating circuit.

In certain non-limiting embodiments of the present disclosure, the rechargeable battery assembly 14 is a traction battery. In certain instances, the battery is configured to power the propulsion of the tracked vehicle 1 and/or the movement of at least one of the accessories selected from the following group: blade 11, winch 12, tiller 10.

The electric motor assembly 13 can comprise one or more electric motors in series and/or in parallel, which directly or indirectly operate, in certain instances through the power transmission 16 or another power transmission, at least one of: first drive wheel 5, second drive wheel 6, tiller 10, blade 11, winch 12.

In certain non-limiting embodiments of the present disclosure, the tracked vehicle 1 comprises a cooler assembly 32, which can be integrated in whole or in part into the heater assembly 31 or work together with all or part of the heater assembly. By way of non-limiting examples, such a heater assembly and/or cooler assembly can share one or more respective heating and cooling circuits, or be separate therefrom in whole or in part, such as by having separate heating and cooling circuits.

In certain non-limiting embodiments, the cooler assembly 32 can comprise one single cooler with one or more cooling circuits; or several coolers, which are independent of one another, such as each with its own cooling circuit; or one or more coolers, wherein one or more or all work together in one or more groups of coolers, wherein the coolers of a same group of coolers share a same cooling circuit.

In certain non-limiting embodiments of the present disclosure, the power transmission 16 is a predominantly hydraulic power transmission and comprises a mechanical transmission 18, five pumps 19, 20, 21, 22 and 23, hydraulic ducts 24, such as of the flexible type, and five hydraulic actuators 25, 26, 27, 28 and 29.

The mechanical transmission 18 is coupled, on one side, to the electric motor assembly 13 and, on the other side, to a first group of pumps comprising the pumps 19 and 21 and to a second group of pumps comprising the pumps 20, 22, 23, so as to transmit the motion received from the electric motor assembly 13. Each pump 19, 20, 21, 22 and 23, through hydraulic ducts 24, is coupled to one of the hydraulic actuators 25, 27, 26, 28 and 29, respectively.

In certain embodiments, the hydraulic actuator 25 is mechanically coupled to the second drive wheel 6 to provide it with mechanical and/or kinetic energy. In certain embodiments, the hydraulic actuator 27 is mechanically coupled to the first drive wheel 5 to provide it with mechanical and/or kinetic energy. In certain embodiments, the hydraulic actuator 28 is mechanically coupled to the tiller 28 to provide it with mechanical and/or kinetic energy. In certain embodiments, the hydraulic actuator 27 is mechanically coupled to the winch 12 to provide it with mechanical and/or kinetic energy. In certain embodiments, the hydraulic actuator 29 is mechanically coupled to the blade 11 to provide it with mechanical and/or kinetic energy. As mentioned above, in one or more embodiments, one or more of the tiller 10, the blade 11 and the winch 12 may be omitted and, in this case, the relative actuator and the relative pump coupled to the omitted accessory are omitted.

In certain embodiments (not shown in the figures), the electric motor assembly 13 comprises a further electric motor coupled, in certain instances, directly, to the first drive wheel 5 and a further electric motor coupled, in certain instances, directly, to the second drive wheel 6. In these embodiments, the pumps 19 and 20 of the power transmission 16 are omitted and the actuators 25 and 27 of the power transmission 16 are omitted and replaced by the respective further electric motors electrically connected to the rechargeable battery assembly 14 and powered by it with or without the use of respective inverters. In these embodiments, the power transmission 16 powers at least one of the accessory devices in a hydraulic manner as discussed above, in particular at least one of the devices chosen from the group of devices comprising: blade 11, tiller 10, winch 12.

In certain alternative embodiments (not shown in the figures), the power transmission 16 is a predominantly electric or mixed electric and hydraulic power transmission. In certain instances, one or more of the pumps 19, 20, 21, 22 and 23 are replaced by one or more electric generators or omitted. In certain instances, one or more of the respective hydraulic actuators 25, 26, 27, 28 and 29 are replaced by respective electric actuators, which are powered by possible electric generators and/or inverters or directly by the rechargeable battery assembly 14. In certain instances, the respective hydraulic ducts 24 are replaced by electrical cables. In these embodiments in which the tracked vehicle 1 is a plug-in hybrid electric vehicle (also called PHEV), in addition to the above-mentioned elements, the plug-in hybrid electric vehicle further includes an internal combustion engine coupled to the power transmission 16 to provide mechanical energy, such as kinetic energy, to the operating devices 9.

In certain embodiments, the rechargeable battery assembly 14 is configured to power the movement of at least one of the accessories selected from: the winch 12, the tiller 10, the blade 11; and/or to power a propulsion of the tracked vehicle, in particular by moving the first and/or the second drive wheel 4,5 and consequently the tracks 3, 4 of the tracked vehicle 1. In certain embodiments, the rechargeable battery assembly 14 is a traction battery.

In certain embodiments, the electronic control unit 17 is configured to operate in a first operating mode when the rechargeable battery assembly 14 is not fully charged or when the charge is below a given charge threshold, for example below 90% or 95% or 99%. In the first operating mode, the electronic control unit 17 requests and receives current from the electrical connector 31 and supplies it to the rechargeable battery assembly 14 and, in certain instances, to the heater assembly 30 and/or to the cooler assembly 32 and/or to other utilities of the tracked vehicle 1 until the rechargeable battery assembly 14 is fully charged.

In certain embodiments, the electronic control unit 17 is configured to operate in a second operating mode when the rechargeable battery assembly 14 is fully charged or when the charge exceeds a given charge threshold, for example 90% or 95% or 99%. In the second operating mode, the electronic control unit 17 is configured to continue to request and receive at least a minimum value of current through the electrical connector 31 continuously and without interruptions and to supply with the current at least one of the heater assembly 30 and/or the cooler assembly 32 and/or another utility of the tracked vehicle 1. In certain instances, the electronic control unit 17 is configured to control at least one of the heater assembly 30 and/or the cooler assembly 32 and/or another utility of the tracked vehicle 1, so that at least one of the three, even alternatively, consumes at least a predetermined minimum value of current. The predetermined minimum value is greater than or equal to a given minimum current threshold, such as, but not limited to, equal to 0.5 Ampere or 1 Ampere.

In certain embodiments, the heater assembly 30 is configured to heat at least one element selected from the group comprising: cabin 9; rechargeable battery assembly 14; oil of the hydraulic circuit 24 and/or of another hydraulic circuit of the tracked vehicle 1; another portion of the tracked vehicle 1. The heater assembly 30 is, in certain instances, controlled by the electronic control unit 17 so that the electronic control unit 17 indicates when the heater assembly is to be operated, in particular in the second operating mode.

In certain embodiments, the electronic control unit is configured to control the heater assembly 30 so that the temperature of the rechargeable battery assembly 14 is always maintained within a first allowed operating temperature range, in which the rechargeable battery assembly 14 is able to supply current when required.

In certain embodiments, the electronic control unit is configured to control the heater assembly 30 so that the temperature of the rechargeable battery assembly 14 is always maintained within a second optimal operating range, in which the rechargeable battery assembly 14 can supply, when required, the maximum nominal current. In certain embodiments, the second optimal operating range is a sub-set of the first operating temperature range.

In certain embodiments, the heater assembly 30 is configured to heat at least one liquid flowing, in a direct manner and/or through a heat exchanger, in at least one element selected from the group comprising: cabin 9; rechargeable battery assembly 14; oil of the hydraulic circuit 24 and/or of another hydraulic circuit of the tracked vehicle 1; another portion of the tracked vehicle 1.

In certain embodiments, the cooler assembly 32 is configured to cool at least one element selected from the group comprising: cabin 9; rechargeable battery assembly 14; oil of the hydraulic circuit 24 and/or of another hydraulic circuit of the tracked vehicle 1; a portion of the tracked vehicle 1. In certain instances, the cooler assembly is controlled by the electronic control unit so that the electronic control unit indicates when the cooler assembly is to be operated, in particular in the second operating mode. In certain embodiments, the cooler assembly 32 is configured to cool at least one liquid flowing, in a direct manner and/or through a heat exchanger, in at least one element selected from the group comprising: cabin 9; rechargeable battery assembly 14; oil of the hydraulic circuit 24 and/or of another hydraulic circuit of the tracked vehicle 1; another portion of the tracked vehicle 1.

As mentioned above, the heater assembly 31 and the cooler assembly 32 can or cannot share the same heating and cooling circuits, which will be heating and cooling circuits.

In certain non-limiting embodiments of the disclosure, the electronic control unit 27, when in the second operating mode, is configured to operate in a given operating sub-mode, in which it alternately, and, in certain cases, cyclically, powers the cooler assembly 32 and the heater assembly 30. Such a configuration provides that at least one of the cooler assembly and/or the heater assembly always consumes the minimum value of the minimum current and the temperature of at least one element selected from the group comprising: cabin 9; rechargeable battery assembly 14; oil of the hydraulic circuit 24 and/or of another hydraulic circuit of the tracked vehicle 1; another portion of the tracked vehicle 1; is maintained within a respective temperature range. In these embodiments, the respective temperature ranges of at least one element selected from the group comprising: cabin 9; rechargeable battery assembly 14; oil of the hydraulic circuit 24 and/or of another hydraulic circuit of the tracked vehicle 1; another portion of the tracked vehicle 1; can be different from one another.

In certain embodiments, the electronic control unit 17 is configured to control the cooler assembly 32 so that the temperature of the rechargeable battery assembly 14 is always maintained within a first allowed operating temperature range, in which the rechargeable battery assembly 14 is able to supply current when required.

In certain embodiments, the electronic control unit 17 is configured to control the cooler assembly 32 so that the temperature of the rechargeable battery assembly 14 is always maintained within a second optimal operating range, in which the rechargeable battery assembly 14 can supply, when required, the maximum nominal current. In other words, in accordance with the present disclosure, in the second operating mode, the electronic control unit 17 controls the heater assembly 30 and, in certain instances, the cooler assembly 32 and/or another electric utility of the tracked vehicle 1 so that one of them always operates so as to consume at least the minimum current value and ensure that the charging station 50 does not end the charge and disconnect from the tracked vehicle 1.

In certain embodiments, the electronic control unit 17 comprises a timer configured to decide when to activate a heating and/or cooling priority of at least one element selected from the group comprising: cabin 9; rechargeable battery assembly 14; oil of the hydraulic circuit 24 and/or of another hydraulic circuit of the tracked vehicle 1; another portion of the tracked vehicle 1. Such a configuration provides that the temperature of the element is within a respective temperature range at a given instant of time. For example, at a given instant of time prior to the work start time, the electronic control unit 17 activates with priority the heating and/or cooling of the cabin 9 and/or of the battery assembly and/or of the oil of the hydraulic circuit 24 and/or of another hydraulic circuit of the tracked vehicle 1; and/or of another portion of the tracked vehicle 1. As a consequence, the electronic control unit 17 comprises a memory in which the work start time is stored.

As mentioned above, in certain embodiments, the cooler assembly 32 is omitted and, consequently, the parts relating to it must be considered as optional but non-limiting parts of the disclosure, which can be removed.

Certain embodiments of the present disclosure also relate to a charging system 100 comprising the tracked vehicle 1 as described above and a charging station 50 configured to supply alternating current or direct current. In certain such embodiments, the charging system includes an electronic control unit 51 of the charging station 50 configured to operate as master or as slave with respect to the electronic control unit 17 of the tracked vehicle 1. In particular, these embodiments advantageously apply when the charging station 50 (and in particular the electronic control unit 51) operates as a master and the tracked vehicle 1 (in particular the electronic control unit 17) operates as a slave. Such embodiments further apply vice versa since the present disclosure manages to ensure that the tracked vehicle 1 always remains connected to the charging station 50 and has the possibility of powering, in any case and at any time, in particular for the entire duration of the stop, even up to the beginning of the work time, a device of the tracked vehicle 1 selected from the group of devices including the heater assembly 30, the cooler assembly 32, and another utility of the tracked vehicle 1. Such a configuration provides that the rechargeable battery assembly 14 and/or the cabin 9 and/or the oil of one of the hydraulic circuits of the snow groomer vehicle 1 and/or other parts of the tracked vehicle 1 are within a respective desired temperature range throughout the stop and/or at the beginning of the work time and, consequently, the tracked vehicle 1 is ready for use.

Finally, the present disclosure can evidently be subjected to variants, though without going beyond the scope of protection defined by the appended claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1. A method for controlling a tracked vehicle comprising a rechargeable battery assembly, a heater assembly, a cooler assembly, and an electrical connector configured to receive input current, the method comprising:
operating in a first operating mode when the rechargeable battery assembly is at least one of not fully charged and charged to less than a threshold percentage of charge, wherein in the first operating mode, the tracked vehicle requests and receives current and supplies the current to at least the rechargeable battery assembly, and
operating in a second operating mode when the rechargeable battery assembly is at least one of fully charged and charged to at least the threshold percentage of charge, wherein in the second operating mode, the tracked vehicle requests and receives current and is controlled to consume at least a minimum value of current greater than a determined current threshold by continuously and, without interruption, supplying the current to at least one of the heater assembly and the cooler assembly controlled to collectively consume at least the minimum value of current.

2. The method of claim 1, further comprising heating, through the heater assembly, at least one of a cabin of the tracked vehicle, the rechargeable battery assembly, oil of a hydraulic circuit of the tracked vehicle, and a portion of the tracked vehicle to maintain a temperature within a respective temperature range.

3. The method of claim 1, further comprising cooling, through the cooler assembly, at least one of a cabin of the tracked vehicle, the rechargeable battery assembly, oil of a hydraulic circuit of the tracked vehicle and a portion of the tracked vehicle to maintain a temperature within a respective temperature range.

4. The method of claim 1, wherein during at least one time period in the second operating mode, at least one of the cooler assembly and the heater assembly are alternately cycled in operation to consumes at least the minimum value of current.

5. The method of claim 1, wherein during the second operating mode, a temperature of the rechargeable battery assembly is constantly maintained, through at least one of the heater assembly and the cooler assembly, within one of a first allowed operating temperature range and a second optimal operating temperature range.

6. A tracked vehicle comprising:
a rechargeable battery assembly;
a heater assembly;
a cooler assembly;
an electrical connector configured to receive an input current; and
an electronic control unit configured to:
manage the received input current,
operate in a first operating mode when the rechargeable battery assembly is at least one of not fully charged and charged to less than a threshold percentage of charge, wherein in the first operating mode, the electronic control unit is configured to request and receive current from the electrical connector and supply current to at least the rechargeable battery assembly, and
operate in a second operating mode when the rechargeable battery assembly at least one of fully charged and charged to at least the threshold percentage of charge, wherein in the second operating mode, the electronic control unit is configured to request and receive current and control at least one of the heater assembly and the cooler assembly so that they always consume at least a minimum value of current greater than a determined current threshold.

7. The tracked vehicle of claim 6, wherein the electronic control unit is configured to control the heater assembly to heat at least one of a cabin of the tracked vehicle, the rechargeable battery assembly, oil of a hydraulic circuit of the tracked vehicle, and a portion of the tracked vehicle to maintain a temperature within a respective temperature range.

8. The tracked vehicle of claim 6, wherein the electronic control unit is configured to control the heater assembly to heat at least one of a cabin of the tracked vehicle, the rechargeable battery assembly, oil of a hydraulic circuit of the tracked vehicle, and a portion of the tracked vehicle by at least one of heating a liquid circulating directly through the at least one of the cabin of the tracked vehicle, the rechargeable battery assembly, oil of the hydraulic circuit of the tracked vehicle, and the portion of the tracked vehicle and a heat exchanger in at least one of the cabin of the tracked vehicle, the rechargeable battery assembly, oil of the hydraulic circuit of the tracked vehicle, and the portion of the tracked vehicle.

9. The tracked vehicle of claim 6, wherein the electronic control unit is configured to control the cooler assembly to cool at least one of a cabin of the tracked vehicle, the rechargeable battery assembly, oil of a hydraulic circuit of the tracked vehicle and a portion of the tracked vehicle to maintain a temperature within a respective temperature range.

10. The tracked vehicle of claim 6, wherein the electronic control unit is configured to control the cooler assembly to cool at least one of a cabin of the tracked vehicle, the rechargeable battery assembly, oil of a hydraulic circuit of the tracked vehicle and a portion of the tracked vehicle by at least one of cooling a coolant circulating directly through the at least one of the cabin of the tracked vehicle, the rechargeable battery assembly, oil of the hydraulic circuit of the tracked vehicle, and the portion of the tracked vehicle and a heat exchanger in at least one of the cabin of the tracked vehicle, the rechargeable battery assembly, oil of the hydraulic circuit of the tracked vehicle, and the portion of the tracked vehicle.

11. The tracked vehicle of claim 6, wherein during at least one period of time in the second operating mode, the electronic control unit is configured to control at least one of the cooler assembly and the heater assembly to operate by alternating cyclically to consume at least the minimum value of current.

12. The tracked vehicle of claim 6, wherein in the second operating mode, the electronic control unit is configured to control at least one of the cooler assembly and the heater assembly so that a temperature of the rechargeable battery assembly is constantly maintained within at least one of a first allowed operating temperature range and a second optimal operating temperature range.

13. The tacked vehicle of claim 6, wherein the electronic control unit comprises a timer configured to decide when to activate at least one of a heating priority and a cooling priority of at least one of a cabin of the tracked vehicle, the rechargeable battery assembly, oil of a hydraulic circuit of the tracked vehicle and a portion of the tracked vehicle to maintain a temperature within a respective temperature range at a point in time.

14. A charging system comprising:
a tracked vehicle comprising a rechargeable battery assembly, a heater assembly, a cooler assembly, an electrical connector configured to receive an input current, and an electronic control unit configured to:
manage the received input current,
operate in a first operating mode when the rechargeable battery assembly is at least one of not fully charged and charged to less than a threshold percentage of charge, wherein in the first operating mode, the electronic control unit is configured to request and receive current from the electrical connector and supply current to at least the rechargeable battery assembly, and
operate in a second operating mode when the rechargeable battery assembly at least one of fully charged and charged to at least the threshold percentage of charge, wherein in the second operating mode, the electronic control unit is configured to request and receive current and control at least one of the heater assembly and the cooler assembly so that they always consume at least a minimum value of current greater than a determined current threshold; and
a charging station configured to deliver at least one of alternating current and direct current, the charging station comprising an electronic control unit configured to operate as one of a master and a slave with respect to the electronic control unit of the tracked vehicle.
